(19) United States
(12) Patent Application Publication
(10) Pub. No.: US 2012/0078649 A1
(43) Pub. Date: Mar. 29, 2012

(54) SYSTEM AND METHOD FOR MONITORING AND RECORDING PATIENT COMPLIANCE

(76) Inventor: Terry Lee Mushrush, Greer, SC (US)

(21) Appl. No.: 13/241,005

(22) Filed: Sep. 22, 2011

Related U.S. Application Data
(60) Provisional application No. 61/385,878, filed on Sep. 23, 2010.

(51) Int. Cl. G06Q 50/00

(52) U.S. Cl. 705/2

(57) ABSTRACT

A method includes storing a schedule of medicine with an electronic device; entering the medicine consumed by the patient; storing the medicine consumed by the patient; and flowing information regarding the medicine consumed by the patient. The information can be flowed to a medical professional. The electronic device can be a hand-held device.

### CROSS-REFERENCE TO RELATED APPLICATIONS

This application claims priority to U.S. Provisional Application No. 61/385,878, by the same inventor, filed on Sep. 23, 2010, the contents of which are incorporated by reference as fully set forth herein.

### BACKGROUND OF THE INVENTION

1. Field of the Invention

This invention relates generally to monitoring and recording the consumption of medicine by a patient.

2. Description of the Related Art

Insurance companies desire to reduce the number of medical visits experienced by the people they insure because each visit costs the insurance company money. There are a lot of medical visits that are preventable. For example, people often do not take their prescribed medication according to the correct instructions, and this can lead to a medical visit. Some people are prescribed many different medications from different medical professionals, and this can lead to a medical visit if the medications undesirably interact with one another. Hence, it is desirable to have a way to reduce the number of preventable medical visits.

### BRIEF SUMMARY OF THE INVENTION

The present invention involves a software program which utilizes a network based system, wherein the software program monitors and documents the medicines prescribed to and taken by a patient through an electronic device operated by the patient. The invention will be best understood from the following description when read in conjunction with the accompanying drawings.

### BRIEF DESCRIPTION OF THE DRAWINGS

FIG. 1 is flow diagram of a method of monitoring and recording the consumption of medicine by a patient.

### DETAILED DESCRIPTION OF THE INVENTION

The invention involves a software program which is capable of monitoring and recording the consumption of medicine by a patient. The software program provides an accurate daily medication schedule complete with an alert system that informs the patient when it is time to take their medicines. It is desirable to monitor and record the consumption of medicine by the patient for many different reasons. For example, some patient's have difficulty remembering the type of medication they have taken, the time the medication was taken and the amount of medication that was taken. If the consumption of medicine by the patient is monitored and recorded, the patient can review this information to refresh his or her memory.

If the consumption of medicine by the patient is monitored and recorded, a medical professional, such as a Doctor, can more affectively determine if the patient's health has improved or declined. This is useful so that the medical professional can make the appropriate adjustments to the medicine consumed by the patient.

It is also desirable to monitor the consumption of medicine by the patient in case the patient is taken to an emergency room or is seen by another medical professional. This is useful so that the other medical professional can determine what medicines the patient has consumed to better treat the patient.

Many patients follow a medication schedule. A medication schedule provides many different types of information to the patient. For example, a typical medication schedule indicates to the patient the type of medication to take, the time to take the medication and the amount of medication to take.

The invention can be understood with reference to the disclosure of the above-referenced U.S. Provisional Application No. 61/385,878, which includes many screen shots of a software program used to implement the invention disclosed herein. More information regarding software programs used in the medical industry can be found in U.S. Patent Application Nos. 20030130874, 20060294108, 20080140449 and 20100045466, the content of each of which is incorporated by reference as though fully set forth herein. More information regarding software programs used in the medical industry can be found in U.S. Pat. Nos. 4,837,719, 4,970,669, 5,623,242, 5,954,641, 5,963,136, 6,075,755, 6,085,752, 6,421,650, 6,018,289, 6,198,383, 6,985,869, 7,330,101 and 7,639,120, the content of each of which is incorporated by reference as though fully set forth herein. More information regarding software programs used in the medical industry can be found in Foreign References EP 1087322 to Berlet et al. and WO 9938052 to Zarchan, the content of each of which is incorporated by reference as though fully set forth herein. It should be noted that the software program which implements the invention disclosed herein can be operated by many different types of electronic devices, such as a cell phone, desktop computer and laptop computer. One type of cell phone which can be used to operate the software program of the invention disclosed herein is the IPHONE, which is manufactured by Apple, Inc. of Cupertino, Calif.

The software program is operated with an electronic device. The electronic device can be of many different types. In some embodiments, the electronic device is a mobile device and, in other embodiments, the electronic device is a non-mobile device. An example of a electronic device is a hand-held device, such as a laptop computer, tablet personal computer, personal digital assistant and a mobile phone. An example of a non-mobile device is a desktop computer.

A typical electronic device includes a processor for executing instructions in the form of computer code, and a display device for displaying information in response to the processor executing the computer code. In some embodiments, the display device is a touch screen display so that input can be provided to the processor in response to touching the display device. The touch screen display make it easier for patients to operate the electronic device. It is desirable to make it easy to operate the electronic device because some patients lack computer skills or suffer from a condition which makes using a keyboard difficult. For example, some patients may have limited vision and/or limited use of their hands.

The electronic device includes electronic memory for storing desired information. The desired information can be of many different types. For example, the desired information can correspond to a type of medicine. The desired information can correspond to an amount of medicine. The desired information can correspond to a time which corresponds to a time at which a particular type of medicine is supposed to be consumed (i.e. a medication schedule). The desired information can correspond to a time which corresponds to a time at which a particular type of medicine was consumed (i.e. compliance information). It should be noted that the time typically includes a date.

In this embodiment, the software program allows for a medication schedule or compliance information to be stored by the electronic memory. The software can include a security feature so that the information mentioned above is viewable by selected individuals and entities by means of usernames and passwords, or a combination of a patient number and the patient's first and last names. Examples of selected individuals are medical professionals or spouses of patients. Examples of selected entities are hospitals or emergency service providers such as ambulance services. The patient can control how the information mentioned above is shared by controlling access to their username, password and patient number.

The electronic device is capable of communicating with other electronic devices, such as through a communication link. Examples of communication links include wired and wireless communication links. The ability of the electronic device to communicate with other electronic devices allows the memory of the electronic device to be accessed remotely, such as by a medical professional and hospital. This is useful so that the medical professional and hospital can determine the type, time and amount of medicine the patient is consuming. The medical professional and hospital can compare the type, time and amount of medicine the patient is consuming with the medication schedule to determine compliance. The medication schedule can be adjusted through the communication link. The medication schedule can be adjusted by the medical professional, a family member, and a healthcare provider, among others. The software program allows the patient to accept or reject the adjustment to the medication schedule. The patient can accept or reject the adjustment to the medication schedule in response to touching the touch screen display. The electronic device can record who made adjustment to the medication schedule and the patient's response to the adjustment.

It should be noted that the communication link is typically a secure communication link so that access to the electronic device is restricted. The communication link can be secured in many different ways. For example, the electronic device can require a username and password to be provided before the communication link is established. The electronic device can require that a patient identification number be provided before the communication link is established. It should be noted that the establishment of the computer link is typically recorded to make an access record to the electronic device. In this way, it can be determined at a later date who accessed the electronic device and what changes were made, if any, to the medication schedule.

The software program allows the patient to provide information regarding medication schedule non-compliance. The information regarding medication schedule non-compliance can be provided in response to the patient touching the touch screen display. For example, the patient can provide information to the software indicating that the patient is experiencing an undesired side-effect in response to consuming a particular type of medicine. The patient can provide information to the software indicating that the patient missed taking a particular type of medicine at a particular time because the patient was not at home. It should be noted that this non-compliance information can be provided to the medical professional and hospital through the communication link mentioned above.

The software program provides an indication to the patient, wherein the indication corresponds to the medication schedule. The indication can be of many different types. In some situations, the indication is a graphical indication which is displayed by the display device. The graphical indication can be of many different types, such as a color change of the display device. In some embodiments, the graphical indication is displayed for a time and not displayed for another time. In some embodiments, the graphical indication is periodically displayed for a time and not displayed for another time. In some embodiments, the time that the graphical indication is displayed and not displayed is adjusted

In some situations, the indication is a sound indication which is provided by a speaker of the electronic device. In some embodiments, the indication includes a graphical and sound indication. It should be noted that the display device typically displays the time, type of medication and amount of medication.

The indication can correspond to the medication schedule in many different ways. In some embodiments, the indication corresponds to a time that the patient is supposed to consume a particular type of medication, wherein the particular type of medication is indicated by the medication schedule. In some embodiments, the indication corresponds to a time that the patient is supposed to consume a particular type and amount of medication, wherein the particular type and amount of medication is indicated by the medication schedule. In this way, the electronic device allows the patient to comply with the medication schedule.

The electronic device simplifies complex medication schedules by the monitoring screen which displays the medications taken, skipped, or discontinued. This helps the patient maintain compliance and allows the patient to document the rationale if a medicine is not taken.

The electronic device provides many different advantages. The electronic device closes a technological research gap by gathering data from patient self-administration in the home. The electronic device respects HIPAA by allowing only the patient the right to share their access code with their preferred providers and family members.

The electronic device functions independently from the various types of Electronic Medical Records. This allows the patient providers access to the medication schedule from any facility that has internet capability. Updates to the medicine schedule can be made quickly and efficiently and any changes easily reviewed by any party. This meets the requirement of the pillar of interoperability by enhancing the flow of medication information to all involved with the patient's care.

The cost of medication errors will be reduced because the electronic device provides daily guidance for the patient and family to manage the medication administration through use of an accurate medication schedule.

The electronic device allows the medical professionals, family or healthcare providers to build a schedule from a database of available drugs, that can be prescribed for a continuous duration, a limited duration, when needed at the discretion of the patient, or on a complex changeable schedule such as tapering.

The electronic device records the patients personal information. Recording the patient's personal information is useful for many different reasons. Recording the patient's personal information is useful so that the patient can be identified in an emergency situation. Recording the patient's personal information is useful so that a medical professional can review the patient's past medical history.

The electronic device actively monitors the drug schedule and provides the patient with an audio and/or visual alarm when the medication is due. The alarm becomes more vigorous as the drug becomes past due. Alarms require the patient to disposition the drug.

The electronic device is designed to be used with a touch screen tablet PC which does not require the patient to be computer literate.

The electronic device has an administration layer which allows customization of privileges associated with group types. For example, a selected medical professional will be able to change a medication schedule, but the emergency room physician will only be able to view it.

The electronic device is accessible by any device that can access the internet. PC's, Touchscreen tablets, cell phones, or any device that can access the web. The reporting feature allows the patient's medication compliance to be parsed by periods of time, or by drug. These reports can be viewed, printed or emailed. Scheduled e-mailing of the reports can be configured by the patient to be delivered on a periodic basis to a list of people.

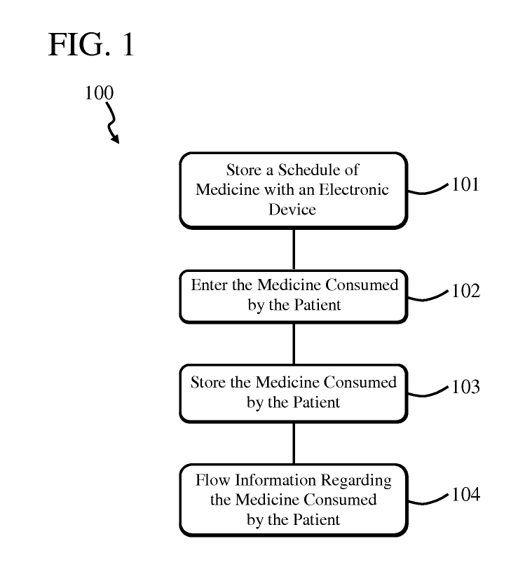

FIG. 1 is a flow diagram of one embodiment of a method 100 of monitoring and recording the consumption of medicine by a patient. In this embodiment, method 100 includes a step 101 of storing a schedule of medicine with an electronic device. The schedule of medicine can be stored with the electronic device in many different ways. In this embodiment, a software program is operated by the electronic device, and the software program allows the schedule of medicine to be stored with the electronic device. In this embodiment, method 100 includes a step 102 of entering the medicine consumed by the patient. The medicine consumed can be stored in many different ways. In some embodiments, the medicine consumed is entering by the patient and/or the patient's caretaker. In this embodiment, method 100 includes a step 103 of storing the medicine consumed by the patient. The medicine consumed by the patient is typically stored in response to being entered. In this embodiment, method 100 includes a step 104 of flowing information regarding the medicine consumed by the patient. The information regarding the medicine consumed by the patient can be flowed in many different ways. In some embodiments, the information regarding the medicine consumed by the patient is flows through a network, such as a wired and/or wireless network.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A method, comprising:
storing a schedule of medicine with an electronic device;
entering the medicine consumed by the patient
storing the medicine consumed by the patient; and
flowing information regarding the medicine consumed by the patient.

2. The method of claim 1, wherein the information is flowed to a medical professional through a network.

3. The method of claim 1, wherein the electronic device is a hand-held device.
